(19) United States
(12) Patent Application Publication
(10) Pub. No.: US 2014/0264136 A1
(43) Pub. Date: Sep. 18, 2014

(54) Crankcase Explosion Relief Valve Using Porous Metal

(71) Applicant: PENN TROY MACHINE COMPANY, INC., Troy, PA (US)

(72) Inventor: Michael Kafka, Troy, PA (US)

(73) Assignee: PENN TROY MACHINE COMPANY, INC., Troy, PA (US)

(21) Appl. No.: 13/837,178

(22) Filed: Mar. 15, 2013

(51) Int. Cl. F02B 77/10; A62C 2/06

(52) U.S. Cl. CPC F02B 77/10; A62C 2/06
USPC 251/359; 169/48; 419/66

(57) ABSTRACT

A crankcase explosion relief valve with an external flame trap made from compressed and sintered porous metal powder. Should an explosion take place, the valve plate will lift, allowing the flame front and exhaust gasses to enter the device. The exhaust gasses exit the valve though a circular flame trap made of porous metal. The circular flame trap is of a ribbon shape as to increase the amount of permeable area on the component. Due to the narrow interconnected porosity, flames will not be able to propagate past the porous material, while the exhaust gasses are able to freely pass through. In another embodiment, the porous material component is in the form of a plurality of cups.

### BACKGROUND OF THE INVENTION

1. Field of the Invention

The invention pertains to the field of large internal combustion engines and natural gas compressors. More specifically, the invention pertains to the crankcases of these devices.

2. Description of Related Art

A combustible gas or vapor mixture can potentially be present in the confined space of an engine crankcase. Should there be any hotspots in the crank case, at a temperature close to auto ignition of the gas or vapor mixture, an explosion could occur. The crankcase explosion relief valve is a safety device which mitigates the effects of this type of event. The explosion relief valve will open quickly to vent the rapid pressure rise caused by the explosion, and will also prohibit the propagation of any flame to the exterior of the engine's crankcase.

The origin for the development of crankcase explosion relief valves stems from an incident that occurred on the ship “Reina Del Pacifico” on Sep. 11, 1947. An oil mist, which developed within the crankcase of one of the ship's engines, was auto ignited by a hot spot that had generated on one of the internal components of the engine. This resulted in an explosion which claimed the lives of 28 people aboard the “Reina Del Pacifico”. As a result of this incident, and many other similar happenings, a research group known as the British Internal Combustion Engine Relief Association (BICERA) was formed for the purpose of evaluating the causes of such occurrences, and to develop devices and practices for limiting the effects of engine crankcase explosions.

The typical look of an explosion relief valve is a cylindrical device mounted to a crankcase or engine manifold. Occasionally, these devices will be fitted with a directional cover that surrounds the exterior of the valve. The key operations of an explosion relief valve are flame suppression, swift pressure relief, and rapid resealing in the event of an explosion.

Explosion relief valves differ in the flame arresting method used. Often, the design of the flame arrestor determines the entire form, fit, and pricing of the valve. In the past manufacturers have used oil wetted mesh. In this method, the mesh screen of the valve penetrates inside the crankcase so that it may be wetted with oil during normal operation of the engine. The flame front of the explosion is forced to weave through the narrow gaps of the mesh while being quenched by the oil that is saturated in the mesh screen layers. Other manufacturers use corrugated metal surrounding the outside of the valve plate. When the valve disc opens, the flame front is forced through a series of corrugated metal strips which arrest any flames.

### SUMMARY OF THE INVENTION

A crankcase explosion relief valve is provided, with an external flame trap made from compressed and sintered porous metal powder. Should an explosion take place, the valve plate will lift, allowing the flame front and exhaust gasses to enter the device. The exhaust gasses exit the valve though a circular flame trap made of porous metal. The circular flame trap is of a ribbon shape as to increase the amount of permeable area on the component. Due to the narrow interconnected porosity, flames will not be able to propagate past the porous material, while the exhaust gasses are able to freely pass through. In another embodiment, the porous material component is in the form of a plurality of cups.

### BRIEF DESCRIPTION OF THE DRAWING

FIG. 1 shows a perspective view of a valve assembly.

FIG. 2 shows a sectioned view of the valve assembly of FIG. 1.

FIGS. 3 and 4 illustrate the same sectioned view as shown in FIG. 2, in front isometric and rear isometric exploded views respectively.

FIG. 5 shows an alternate configuration of the porous material incorporated into the valve.

FIG. 6 shows a sectioned view of the valve of FIG. 5

FIG. 7 shows a sectioned detail of a cup and cup bushing from FIG. 5.

### DETAILED DESCRIPTION OF THE INVENTION

FIG. 1 illustrates the primary configuration of the full valve assembly. All of the internal components of the valve are contained by the cap (10), a perforated metal screen (6), and the carrier (1). The entire assembly is fastened together via four partially threaded posts (11) which run through the depth of the valve, connecting the cap (10) to the carrier (1). The carrier (1) and cap (10) are preferably circular, having outer perimeters which are approximately the same size so that the perforated metal screen (6) fits between the outer perimeters of the carrier (1) and the cap (10), forming the walls of the valve. This is illustrated more clearly in FIG. 2.

FIG. 2 depicts a sectioned view of FIG. 1 for further detailed location of all the internal components of the valve. FIG. 3 and FIG. 4 illustrate the same sectioned view as shown in FIG. 2 in front isometric and rear isometric exploded views respectively, in order to show the mating features of the various components in superior detail.

The valve assembly is secured to a crankcase, preferably to an inspection door (not illustrated) by four screws (not illustrated) inserted from the interior side of the inspection door which are secured into the four tapped mounting holes (12) in the carrier (1). The O-ring seal (3) is fitted into a semi-circular O-ring groove (15) which surrounds the central valve inlet (13) of the carrier (1), which in turn is located over an aperture into the crankcase, to allow for passage of gasses from the crankcase into the valve through the valve inlet (13).

The valve plate (4) is fitted over the valve inlet (13) against the O-ring seal (3). The compressed spring (7) forces against the valve plate guide shaft (5) that is mechanically fastened to the valve plate (4). The opposite end of the spring (7) is fitted over the valve guide (9) against its shoulder. A valve guide bushing (8) is inserted into the valve guide socket (22), and mates with the valve plate guide shaft (5). The valve guide (9) is fitted into the cap pocket (21) on the inner side of the cap (10). The cap (10) is secured to the carrier (1) by four posts (11) that are assembled through the four post holes (18) in the cap (10) into the four corresponding tapped post holes (14) in the carrier (1).

A porous metal ribbon flame arrester (2) has a ribbon body preferably formed in a sinuous shape so as to increase the length of the ribbon and the surface area relative to a circular form, surrounds all of the internal valve components, and is fitted between the carrier (1) and the cap (10) in the lower ribbon groove (16) and the upper ribbon groove (20) respectively.

A perforated metal screen (6) is also placed between the carrier (1) and the cap (10) in the lower screen slot (17) and the upper screen slot (19) respectively.

The distance between the carrier (1) and the cap (10) is controlled by the height of the porous metal ribbon flame arrester (2) that the two components are mated with. This distance sets the initial compressed height of the spring (7), thus providing the force to compress the O-ring seal (3) which forms the liquid and airtight seal that provides the functionality of the valve.

The lower ribbon groove (16) and the upper ribbon groove (20) secure the proper orientation of the porous metal ribbon flame arrester (2) and allow it to penetrate into the interior surfaces of the carrier (1) and the cap (10). This provides a seal around the edges of the porous metal ribbon, restricting the flame front from bypassing the porous metal ribbon flame arrester (2).

The perforated metal screen (6) is rolled and welded together forming a continuous circular piece. This adds mechanical strength to support the porous metal ribbon flame arrester (2) against hoop stresses that are experienced during an explosion. A rather open configuration of perforated material should be used to allow the exhaust gasses to pass through the component without significantly restricting flow rate and negatively affecting pressure drop.

When auto ignition of a gas or vapor occurs within the confined crankcase of an engine, the deflagration causes the gasses within the confined space to violently expand, resulting in a sudden surge in pressure. The pressure swell forces the valve plate (4) to lift open and the spring (7) to compress further. As the valve plate (4) lifts, the valve plate guide shaft (5) slides into the valve guide bushing (8), controlling the motion of the valve plate (4). A small weep hole (not illustrated) is preferably drilled through the valve guide (9) and the valve guide bushing (8) to allow the valve plate guide shaft (5) to actuate freely and quickly.

The flame front and expanding exhaust gasses are thus allowed to pass through the valve inlet (13) into the device. The exhaust gasses then exit the valve by passing through the porous metal ribbon flame arrester (2) and the perforated metal screen (6) to atmosphere, reducing the peak pressure experienced within the engine crankcase, cooling the exhausted gasses, and halting the propagation of flames to the surrounding atmosphere. Once the overpressure has been successfully vented, the spring (7) will cause the valve plate (4) to reseal against the O-ring seal (3).

It is important that during the explosion the internal valve components should not be damaged in a way that would preclude their ability to re-form an airtight seal. A slight vacuum is normally experienced immediately following an explosion. If the valve is not properly sealed, fresh air could be drawn back into the engine crankcase and result in a secondary explosion. The explosion relief valve and all associated components are preferably designed to withstand a minimum of two successive explosions and still form an airtight seal.

The body of the porous metal ribbon flame arrester (2) can be formed by a process of isostatic compaction or axial compaction of 100μ grade, 316L stainless steel metal powder particles. The process of isostatic compaction is more desirable for this application as the part can be formed with little or no density gradient, yielding a more uniform permeability across all of the component surfaces. The large micron grade of the material is selected to further promote increased permeability. A larger micron grade of metal powder particles would have negative effects on the mechanical properties of the formed component, as the larger particles would result in larger pore sizes, which in turn would decrease the density of the part.

The density of the porous metal ribbon flame arrester (2) is preferably 35% to 40% porous in order to balance permeability and mechanical strength of the material. The interconnected porosity throughout the porous metal ribbon flame arrester (2) creates a vast array of open pathways between the interior and exterior surfaces of the component, resulting in a permeable material. The size of the metal powder particles and pores makes the resulting interconnected porosity pathways extremely intricate and narrow. By forcing the flame front through this interconnected porosity, propagation of a flame through the material is reduced.

Additionally, these intricate pathways throughout the porous metal ribbon flame arrester (2) naturally have a vast amount of surface area. This tremendous amount of surface area allows the porous metal ribbon flame arrester (2) to act as a heat sink, efficiently dissipating heat energy from the exhaust gasses and flame front throughout the porous material. This results in a reduced temperature range of the exhaust gasses, which are often vented into an area where workers are in close proximity, and therefore adds an extra element of safety to the design of the crankcase explosion relief valve.

Furthermore, the thickness of the porous metal component also has a significant impact on mechanical strength, permeability, and heat transfer. Thickening the material will result in an enhancement in mechanical strength by increasing the total cross sectional area of the metal across the thickness of the part, while decreasing the permeability by further complicating the interconnected porosity in the component, and increasing the chances of creating isolated porosity.

Additionally, the complex interconnected pathways of porosity will result in a greater amount of surface area throughout the part and volume of porous material for increased capacity for heat transfer and absorption. Thinning of the part will yield inverse effects. Therefore, it will be understood that the factors of surface area, thickness, micron grade, material selection, and density will preferably be balanced in order to safely relieve pressure, quench the exhaust gasses, and arrest the flame front.

In an embodiment of the invention, the carrier (1), cap (10), and perforated metal screen (6) are made of an aluminum alloy material such as 6061-T6, 7075-T6, 5052-H32, 2024-T6, or similar alloy. This will help to keep the components light weight, and take advantage of thermal conductivity properties to draw heat away from the porous metal ribbon flame arrester (2) and dissipate the heat quickly to the surrounding atmosphere.

The porous metal ribbon flame arrester (2), valve guide (9), and valve plate guide shaft (5) are preferably made of a corrosion resistant material such as 316L stainless steel. The porous metal ribbon flame arrester (2) may also be made of a different metal powder particle composed of other nickel based alloys such as Monel® nickel-copper alloy or Inconel® nickel-chromium alloy (both from Huntington Alloys Corporation, Huntington, W. Va.), or one of the Hastelloy® nickel-based high-performance alloys or other Haynes® alloys from Haynes International, Kokomo, Ind.

The O-ring seal (3) is preferably made of a corrosion and heat resistant rubber or synthetic rubber composition such as Viton® fluoroelastomer from DuPont.

FIG. 5 shows an alternate configuration of the porous material incorporated into the valve. FIG. 6 and FIG. 7 show this configuration in greater detail. This configuration of the porous metal flame arrester uses a porous metal cup (26) which is welded to a cup bushing (25) of the same material. These components are integrated into the valve by welding the bushing to the perforated cap (24) from the exterior of the assembly. The perforated cap (24) is secured in the alternate carrier (23) via a large diameter carrier thread (29).

The alternate carrier (23) is secured to a crankcase inspection door (not illustrated) by four screws (not illustrated) inserted from the interior side of the crankcase inspection door which are threaded into the four tapped alternate carrier mounting holes (27).

Exhaust gasses flow into the valve through the alternate carrier valve inlet (28) into the device and exit through the numerous porous metal cups (26) which function in the same manner and may be made of the same materials as the porous metal ribbon flame arrester (2) described above. All of the other internal components of the valve are similar in form and function to those previously described, and therefore are not shown in this configuration.

Also, the carrier of either design may be integrated directly into the crankcase inspection door as a feature of the door rather than bolting to the door as a separate component. Welding to a crankcase inspection door may be performed as well, so long as the material is suitable to do so.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A crankcase explosion relief valve comprising:
a carrier for attachment to a crankcase, having an outer perimeter, a lower surface for attachment to a crankcase, an upper surface and a central valve inlet passing through the carrier for passage of gasses from an aperture in the crankcase into the valve;
a cap having an outer perimeter, an upper surface and a lower surface;
a perforated metal screen having a height extending from the outer perimeter of the upper surface of the carrier to the outer perimeter of the lower surface of the cap;
a valve seal around the central valve inlet of the carrier;
a valve plate, biased by a compressed spring against the valve seal, closing the central valve inlet of the carrier; and
a porous metal ribbon flame arrester fitted between the upper surface of the carrier and the lower surface of the cap, radially inside the perforated metal screen.

2. The valve of claim 1, in which the upper surface of the carrier has a lower ribbon groove, and the lower surface of the cap has an upper ribbon groove, and the porous metal ribbon flame arrester is fitted into the lower ribbon groove and the upper ribbon groove, so that a flame front passing from the valve inlet is restricted from bypassing the porous metal flame arrester.

3. The valve of claim 1, in which the porous metal flame arrester is formed in a sinuous shape.

4. The valve of claim 1, in which the porous metal flame arrester is formed by compaction of metal powder particles.

5. The valve of claim 4, in which the compaction is isostatic.

6. The valve of claim 4, in which the metal powder particles are stainless steel.

7. The valve of claim 4, in which the metal powder particles are a nickel alloy.

8. The valve of claim 1, in which a density of the porous metal ribbon flame arrester is between 35% and 40% porous.

9. A flame arrester for a crankcase explosion relief valve, comprising a ribbon body formed of porous metal by compaction of metal powder particles.

10. The flame arrester of claim 9, in which the ribbon body is formed in a sinuous shape.

11. The flame arrester of claim 9, in which the compaction is isostatic.

12. The flame arrester of claim 9, in which the metal powder particles are stainless steel.

13. The flame arrester of claim 9, in which the metal powder particles are a nickel alloy.

14. The flame arrester of claim 9, in which a density of the porous metal is between 35% and 40% porous.

15. A method of manufacturing a flame arrester for a crankcase explosion relief valve comprising compacting metal powder particles into a porous metal ribbon body.

16. The method of claim 15, in which the ribbon body is formed in a sinuous shape.

17. The method of claim 15, in which the compaction is isostatic.

18. The method of claim 15, in which the metal powder particles are stainless steel.

19. The method of claim 15, in which the metal powder particles are a nickel alloy.

20. The method of claim 15, in which a density of the porous metal is between 35% and 40% porous.
